(19) United States
(12) Patent Application Publication
(10) Pub. No.: US 2009/0177544 A1
(43) Pub. Date: Jul. 9, 2009

(54) Campaign system, campaign method, and campaign service program

(75) Inventor: Yasuo Sugahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/318,753

(22) Filed: Jan. 7, 2009

(30) Foreign Application Priority Data
Jan. 8, 2008 (JP) 2008-001282

(51) Int. Cl. G06Q 30/00

(52) U.S. Cl. 705/14

(57) ABSTRACT

A first server for providing a service site that provides a user, who operates a user terminal, with a given service, generates a unique identifier when a service provided to a certain user satisfies a given condition, generates a network address with the first server set as a destination and with the identifier, registers information indicating that an authority is valid in association with the identifier in a storage device, and notifies the user of the network address. The network address represents an authority for enabling the user to receive granting of a given privilege from a campaign site provided on a second server.

### CROSS-REFERENCE TO RELATED APPLICATIONS

This application is related to and claims priority to Japanese patent application No. 2008-1282, filed on Jan. 8, 2008 in the Japan Patent Office, the entire contents of which are incorporated by reference herein.

### BACKGROUND

1. Field of the Invention

This technique relates to a campaign system that executes processing for granting an incentive to a customer as a campaign such as sales and promotion through a network, a campaign method for executing the campaign using a server apparatus accessible from a terminal of the customer through the network, and a campaign service program for causing a computer functioning as the server apparatus to carry out the campaign method.

2. Description of the Related Art

Along with the spread of the Internet in recent years, various campaigns are conducted in sites on the Internet. A representative example of the campaigns is a campaign for granting a fixed incentive to a user who accesses a specific site on the Internet. Such a campaign, for example, is carried out for a user who purchases a specific commodity or a specific service through online shopping in a site that offers an online shopping service on the Internet. The campaign is also carried out for the purpose of acquiring user information on a user who looks at an advertisement of a commodity in a site that advertises the commodity on the Internet. Examples of an incentive granted to the user by the campaign include a commodity or a service used in combination with a sold commodity, free provision of other commodities or services, coupons with which the commodities or the services can be purchased at a given discount rate, or an authority for entry to a prize contest for acquiring commodities, services, or coupons.

Conventionally, this kind of campaign is carried out in a separate page inside the online shopping site or the commodity advertisement described above. However, recently, “cooperation between dealers” is also frequently carried out. In the cooperation between dealers, a dealer (e.g., a consignee as an advertisement company) different from a dealer that manages a site for performing online shopping or commodity advertisement (a consignor) is entrusted by the latter dealer to grant, in a site of the latter dealer, an incentive as a part of the campaign to a customer of the latter dealer. A concept of cooperation of the respective sites in that case is shown in a conceptual diagram of FIG. 13.

In FIG. 13, a terminal 100 of a user is accessible through the Internet N to a site for online shopping (hereinafter referred to as “shopping site”) 101 managed by the consignor, and a site managed by the consignee to grant, on behalf of the consignor, an incentive as a part of a campaign (hereinafter referred to as “campaign site”) 102. When the user accesses the shopping site 101 and places an order for a commodity by operating the terminal 100, the shopping site 101 grants to the user an access authority for accessing a page concerning the campaign entrusted by the consignor (hereinafter referred to as “campaign dedicated page”) in the campaign site 102. Specifically, a URL of the campaign dedicated page (hereinafter referred to as “campaign dedicated URL”) is generally undisclosed to the public and the campaign dedicated URL is notified only to the user as information indicating the access authority. Alternatively, an identifier (ID) and a password are set in the campaign dedicated page and, then, the ID and the password are notified only to the user as information indicating the access authority. When the user granted the access authority by the method described above accesses the page in the campaign site 102 using the terminal 100, the user may receive an incentive presented in the page, e.g., an incentive concerning the campaign that the consignee is entrusted by the consignor.

However, a problem described below occurs when the campaign method by the cooperation between the dealers is adopted.

First, reasonable cost is required to grant an incentive to a customer through a campaign. If a privilege is given to a person who does not satisfy a requirement for a campaign target (e.g., a requirement that the person places an order for a commodity or looks at an advertisement of the commodity), the benefit of the incentive is offset. Therefore, access to the campaign dedicated page should be limited to a user who has true access authority. However, according to the method described above, if a user who is granted the access authority and notified of the campaign dedicated URL (or the ID and the password) leaks these kinds of information to a third party who does not have access authority, such a third party can access the campaign dedicated page and in effect enjoy the privilege.

Therefore, even if a user is granted the access authority once, the number of times the user can access the campaign dedicated page on the basis of one access authority should be limited to a given number of times decided in advance. However, according to the method described above, the user who is granted the access authority and notified of the campaign dedicated URL (or the ID and the password) can access the campaign dedicated page many times and endlessly enjoy the privilege.

When the number of times a user can access the campaign dedicated page on the basis of one access authority is set to plural times, the consignee has to manage in the campaign site how many times an identical user accesses the campaign dedicated page. In order to identify an access of the user, the consignee has to be notified of identification information (customer information) of the user from the shopping site. However, for the user, the consignee is a third party outside the contract. Therefore, the consignor should not disclose personal information of the user to the consignee without permission of the user.

In order to solve the problems described above, for example, it is conceivable to allow access to the campaign dedicated page only in the same session in which the commodity purchase or the like occurs in the shopping site. In that case, if the user discontinues a procedure halfway or communication is disconnected, the user cannot access the campaign dedicated page again. Therefore, the user cannot exercise his or her rights in a flexible manner such as accessing the campaign dedicated page some time after making a commodity purchase or the like. Similarly, when a user purchases a commodity on behalf of a third party, the user cannot transfer the access authority to the campaign dedicated page to the third party.

Therefore, as an object of this technique, the number of times a user, whose condition of use in a service site on a first server satisfies a given requirement, can exercise information indicating an access authority to a campaign site for granting a privilege as a part of a campaign given to the user is limited to a given number of times. This makes it possible to transfer the access authority to a third party. It is also an object of this technique to provide a campaign system, a campaign method, and a campaign service program that can prevent, regardless of the fact that an access authority can be made exercisable at any time, an unauthorized access to a campaign dedicated page by the user or a third party.

### SUMMARY

According to a first aspect of a campaign system devised to solve the above problems, a first server for providing a service site that provides a user, who operates a user terminal, with a given service generates a unique identifier when a service provided to a certain user satisfies a given condition, generates a network address with the first server set as a destination and with the identifier, registers information indicating that an authority is valid in association with the identifier in a storage device, and notifies the user of the network address. The network address represents an authority for enabling the user to receive granting of a given privilege from a campaign site provided on a second server. The user may use the authority or may transfer the authority to a third party and allow the third party to use the authority. In any case, when a person who acquires the network address thereafter transmits, at any time, a message in which the network address is designated as a destination, the first server receives the message. Then, the first server responds, only when information indicating that the authority is valid is registered in the storage device in association with the identifier included in the network address, to a terminal at a message transmission source with redirect information that includes the identifier and redirecting the message to the campaign site to cause the user to request granting of the privilege. Therefore, concerning the person who first transmits the message with the network address set as the destination, it is judged that the information indicating that the authority is valid is registered in the storage device. Therefore, the redirect information is transmitted to the person. The second server receives the message redirected according to the redirect information. When processing for granting the privilege by the campaign site on the basis of the message is completed, the second server generates completion notification that includes the identifier included in the redirect information and transmits the completion notification to the first server. The second server may directly transmit the completion notification to the first server or may generate a return URL and respond to the user terminal with the return URL to thereby transmit the completion notification. When the first server receives the completion notification in this way, the first server updates the information registered in the storage device in association with the identifier included in the completion notification to information indicating that the authority is invalid.

### BRIEF DESCRIPTION OF THE DRAWINGS

FIG. 1 is a block diagram showing a schematic configuration of a network system;

FIG. 2 is a table showing the data structure of a commodity database;

FIG. 3 is a table showing the data structure of a customer database;

FIG. 4 is a table showing the data structure of an order database;

FIG. 5 is a table showing the data structure of a campaign database;

FIG. 6 is a table showing the data structure of an application result database;

FIG. 7 is a flowchart showing processing during online shopping;

FIG. 8 is a flowchart showing processing during one-time URL access;

FIG. 9 is a flowchart showing processing of a job processing server of a campaign site;

FIG. 10 is a flowchart showing processing during access according to a return URL;

FIG. 11 is a diagram showing an example of a screen during online shopping;

FIG. 12 is a diagram showing an example of a registrant information registration screen for campaign application; and

FIG. 13 is a block diagram showing a schematic configuration of a network system in the past.

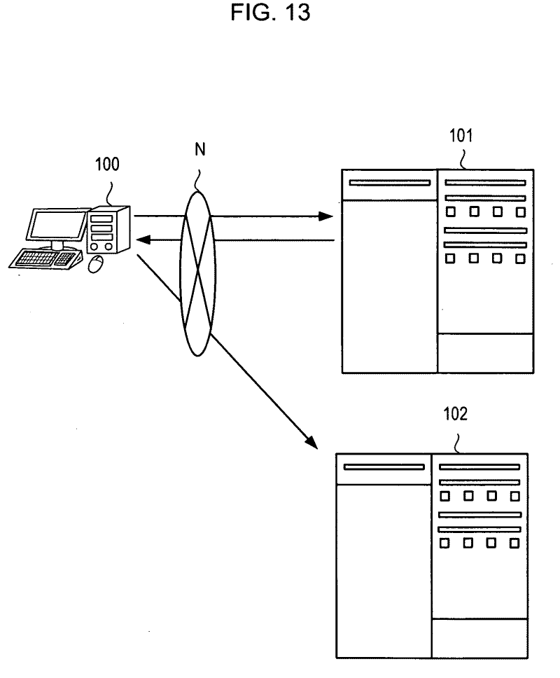

### DETAILED DESCRIPTION OF THE EMBODIMENTS

A campaign system according to an embodiment of this proposal is explained below. In the example explained below, a campaign system according to this technique is configured as a network system that includes a server apparatus for realizing a shopping site (a service site that provides an online shopping service) managed by a consignor, and a server apparatus for realizing a campaign site (a site that grants a privilege of content entrusted by the consignor to a user designated by the consignor as an incentive forming a part of a campaign) managed by a consignee. However, the application of this proposal is not limited to a network system having such a configuration. This proposal may be applied to a network system having a configuration in which a shopping site and a campaign site are realized by an identical server apparatus (a rental server, etc.). The service site managed by the consignor to conduct a campaign is not limited to the shopping site and may be, for example, a site that advertises commodities and services.

### <System Configuration>

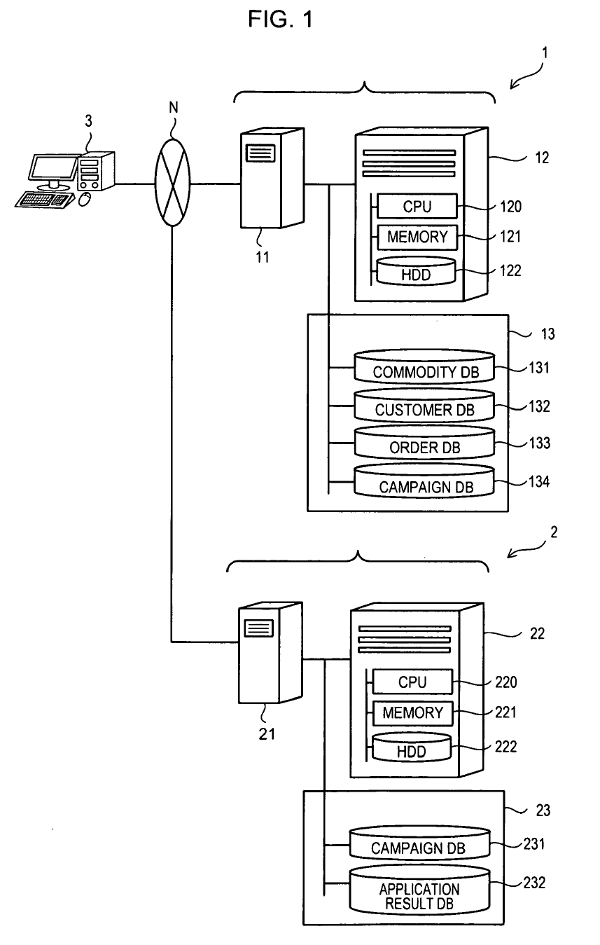

FIG. 1 is a schematic diagram of a network system that implements the campaign system according to the embodiment. As shown in FIG. 1, the network system includes a server group (a WEB server 11, a job processing server 12, and a database server 13) configuring a shopping site 1, a server group (a WEB server 21, a job processing server 22, and a database server 23) configuring a campaign site 2, and a large number of user terminals 3 (only one is shown in FIG. 1) that are physically connected mutually through the Internet N and are able to communicate with one another.

### [Shopping Site]

The WEB server 11 configuring the shopping site 1 responds to a request for WEB data requested by a request message sent from the user terminal 3 or the campaign site 2 to the WEB server 11. Alternatively, the WEB server 11 instructs the job processing server 12 to perform requested processing. When a result of the processing (a return value) is returned from the job processing server 12, the WEB server 11 responds to the request message transmission source at the user terminal 3 or the campaign site 2, with the result.

The job processing server 12 is an apparatus that executes the processing instructed by the WEB server 11. The job processing server 12 incorporates a hard disk 122 having installed therein various programs (CGI programs) that indicate procedures of the processing, a CPU 120 that reads out and executes these programs as appropriate according to instruction content, and a main memory 121 in which a work area of the CPU 120 is expanded.

One kind of processing executed by the job processing server 12 is processing for providing a user, who operates the user terminal 3 that transmits a request message to the shopping site 1 designating a given URL, with a service of online shopping. The job processing server 12 generates, according to parameters included in the request message, screen data for causing the user terminal 3 to display a list of a designated commodity group and responds to the user terminal 3 with the screen data, generates screen data for causing the user terminal 3 to display an explanation of a designated commodity and responds to the user terminal 3 with the screen data, generates screen data for causing the user to express the user's intention to decide purchase of the designated commodity and responds to the user terminal 3 with the screen data, creates slip data representing content of the decided commodity purchase, and transmits an email (an order reception mail) notifying that an order is received (a purchase agreement is concluded) to the user terminal 3.

Moreover, as processing equivalent to this technique, when purchase of a commodity is decided, the job processing server 12 generates, if the decided commodity is a campaign target, a URL (a one-time URL) indicating an access authority for receiving a privilege as an incentive from the campaign site 2 and describes the URL in the order reception mail. When the job processing server 12 receives a request message in which the one-time URL is designated, the job processing server 12 issues a URL for redirecting the request message to a campaign site 3 to the user terminal 3 as long as the number of times of reception of the one-time URL is within a given limit.

The network may be any kind of network as long as the network is a computer network and may be a personal computer network, a VAN, or the Internet. The network address is a concept that includes a URL for the Internet. The service provided by the service site on the first server includes online shopping, advertisement of commodities, and content delivery. The privilege granted by the campaign site on the second server includes a grant of tangible objects such as commodities and coupons, delivery of download data such as content and right information, or acceptance to apply for a prize.

Besides the conditions described above, an application condition for a campaign can be set in various ways. For example, the campaign may be applied when a given quantity or more of specific commodities is purchased, applied when a specific quantity of commodities are purchased as a set, or applied when a purchase amount sum is equal to or larger than a given amount. In such cases, when the kind of commodities that a user decides to purchase, the quantity of the commodities, or the sum of purchase amounts of the commodities satisfies a condition of any campaigns set in advance, a one-time URL that includes a kind of the campaign as a parameter may be generated.

The database server 13 has a storage device that stores data forming various databases (a commodity database 131, a customer database 132, an order database 133, and a campaign database 134). The database server 13 writes data in and reads data out from these databases 131 to 134 according to a request from the job processing server 12 that is executing the processing. The data structure of each of these databases 131 to 134 is explained below.

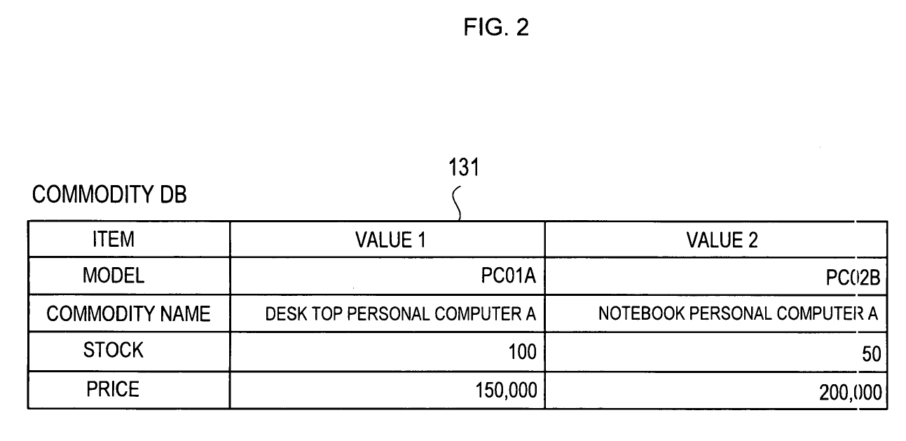

First, as shown in FIG. 2, the commodity database 131 stores a model, a commodity name, the number of stocks, and a sales price for each of the kinds of commodities sold in the shopping site 1.

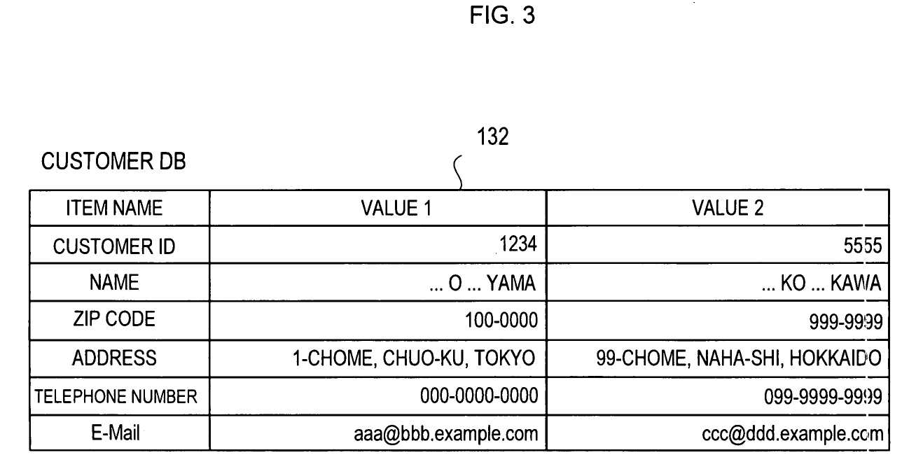

As shown in FIG. 3, the customer database 132 stores personal information (a customer identifier (ID), a name, a zip code, an address, a telephone number, and an email address) for each of customers in the shopping site 1 (users who purchased commodities in the shopping site 1 in the past).

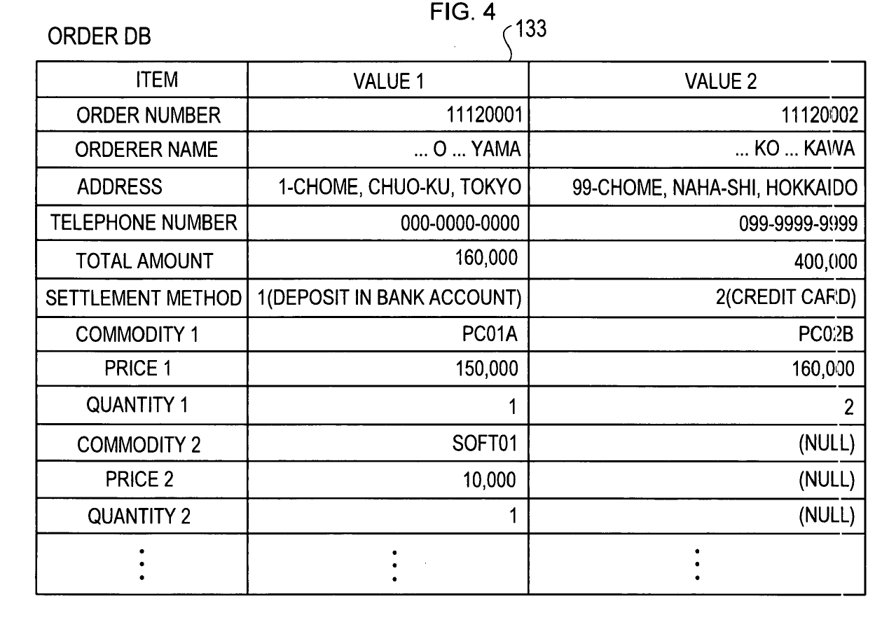

The order database 133 is a table that records content of slip data concerning commodity purchases decided by each of the customers. As shown in FIG. 4, data of each slip (each column in a table shown in FIG. 4) include information such as an order number for uniquely identifying an individual order, an orderer name, an orderer address, an orderer telephone number, a sum of purchase amounts (Total amount), a settlement method (1: deposit in a bank account, or 2: credit card settlement), a model name of a purchased commodity (Commodity 1, etc.), a price of the commodity (Price 1, etc.), and a quantity of the commodity (Quantity 1, etc.).

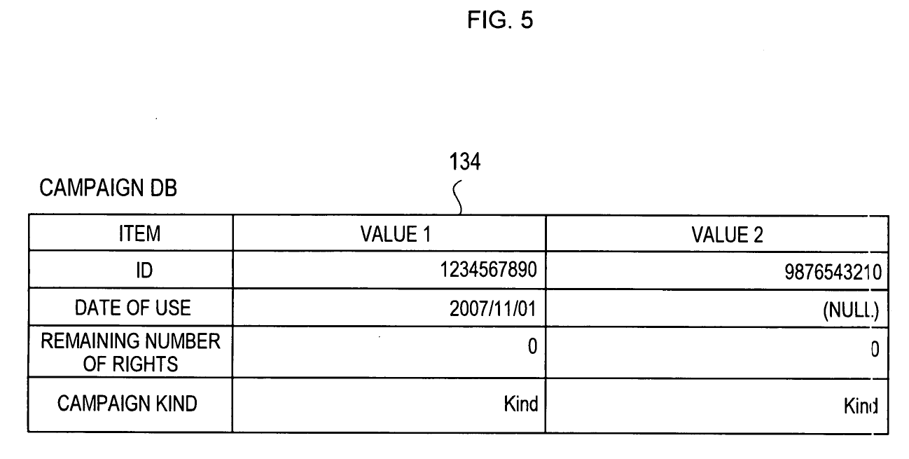

The campaign database 134 stores in association with one another, although not shown in the figure, a campaign kind for uniquely identifying the kind (Kind), application conditions, the number of times that a user can receive a privilege (Remaining number of rights), and a URL of a consignor campaign site for this campaign for each kind of campaign. Moreover, as shown in FIG. 5, the campaign database 134 stores, for each one-time URL issued by the shopping site 1, an ID for uniquely identifying the one-time URL, a recent date and time when the user accesses the campaign site 2 using the ID (Date and time of use), a remaining value of the number of rights (Remaining number of rights), and a campaign kind.

The shopping site 1 is actually configured by connecting the server apparatuses 11 to 13 with a LAN connected to the Internet N through a router (not shown). However, all or several of the functions of the server apparatuses 11 to 13 may be realized by one server apparatus.

On the other hand, the WEB server 21 configuring the campaign site 2 instructs the job processing server 22 to perform processing requested by a request message sent to the Web server 21 from the user terminal 3 (a message redirected from the shopping site 1). When a result of the processing (a return value) is returned from the job processing server 22, the WEB server 21 responds to the user terminal 3 at a request message transmission source with the result.

The job processing server 22 is an apparatus that executes the processing as instructed by the WEB server 21. The job processing server 22 incorporates a hard disk 222 having installed therein various programs that indicate procedures of the processing, a CPU 220 that reads out and executes programs as appropriate according to instruction content, and a main memory 221 in which a work area of the CPU 220 is expanded.

One kind of processing executed by the job processing server 22 is processing for granting, according to a request message from the user terminal 3 redirected on the basis of the one-time URL, an incentive to a person who is operating the user terminal 3 (a customer or a person who is assigned an access authority from the customer) as a part of a campaign. When a privilege granted as the incentive is delivery of download data, the job processing server 22 does not need to collect personal information of a person to whom the privilege is granted. However, when the privilege is grant of a tangible object such as a promotion product or a coupon, the job processing server 22 independently acquires, from the person to whom the privilege is granted, personal information necessary for dispatching the tangible object to be granted.

The database server 23 has a storage device that stores data forming various databases (a campaign database 231 and an application result database 232). The database server 23 writes data in and reads data out from these databases 231 and 232 according to a request from the job processing server 22 that is executing the processing. The data structure of each of the databases 231 and 232 is explained below.

When there are numerous kinds of campaigns that the campaign site 2 can be entrusted with, the campaign database 231 defines, for each of the campaign kinds (Kind), content of a privilege granted to the user as an incentive in the campaign.

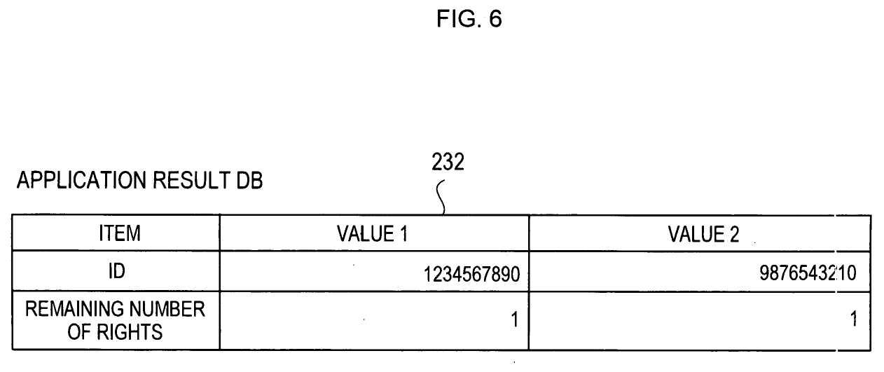

As shown in FIG. 6, the application result database 232 records, concerning IDs of all one-time URLs included in redirect messages that the job processing server 22 received in the past, a minimum value of a remaining number of rights included in redirect messages in combination with the IDs.

The campaign site 2 is actually configured by connecting the server apparatuses 21 to 23 with a LAN connected to the Internet N through a router (not shown). However, all or several of the server apparatuses 21 to 23 may be realized by one server apparatus.

### [User Terminal]

The user terminal 3 is a personal computer with a normal configuration that establishes an Internet connection function by executing an operating system and a WEB browser program.

### <Processing Content>

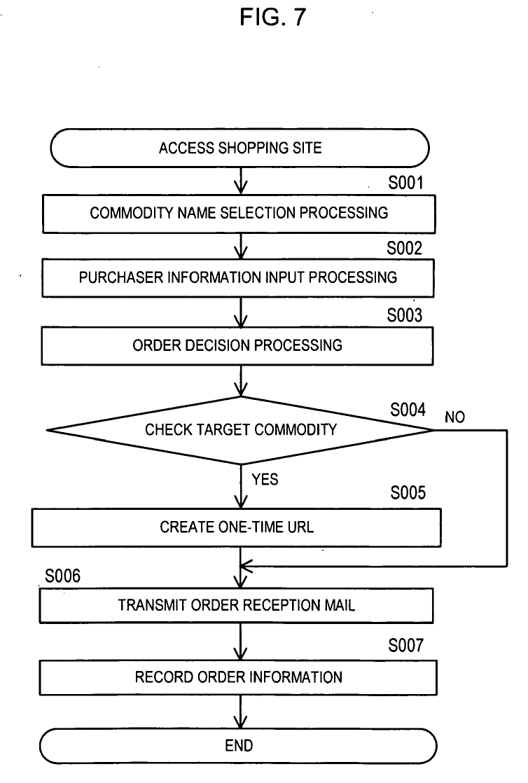

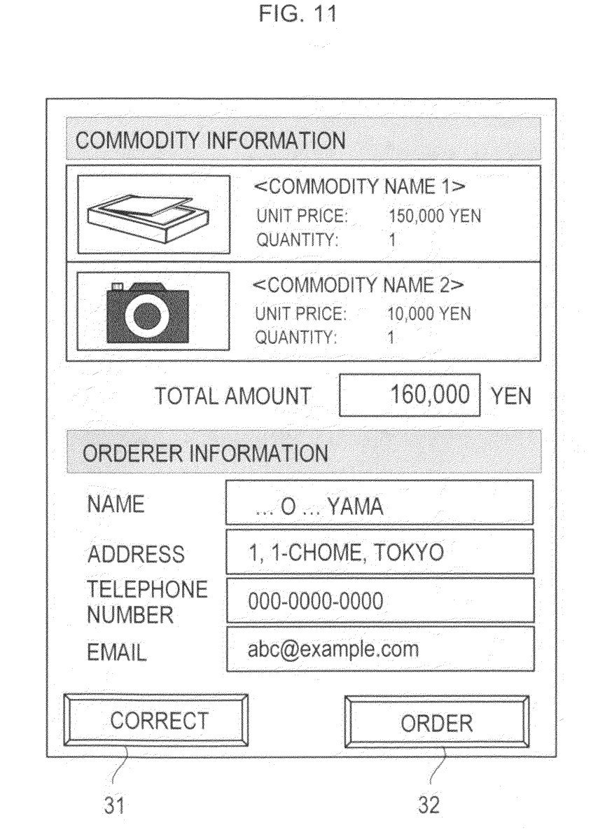

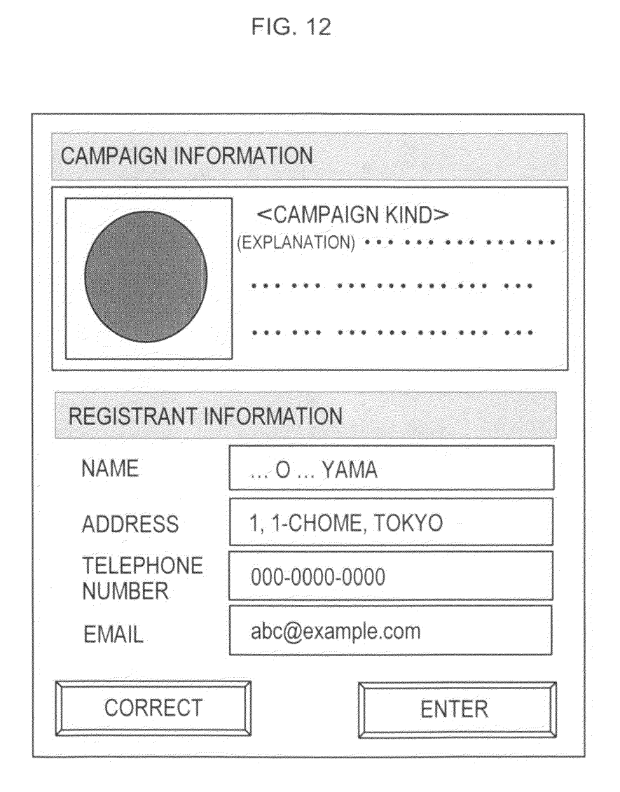

Processing executed by the job processing server 12 (the CPU 120 that reads a program from the hard disk drive 122) of the shopping site 1 and processing executed by the job processing server 22 (the CPU 220 that reads a program from the hard disk drive 222) of the campaign site 2 in the network system configured as described above are explained with reference to flowcharts of FIGS. 7 to 10 and examples of screens shown in FIG. 11 and 12.

The flowchart of FIG. 7 is started when the WEB server 11 receives a request message in which a URL of a top page of the shopping site 1 is designated and instructs the job processing server 12 to perform processing of online shopping.

In first step S001 after the process is started, the job processing server 12 executes commodity selection processing. The job processing server 12 exchanges a message with the user terminal 3 at a message transmission source to thereby sequentially transmit screen data of a page requested by a user who operates the user terminal 3 and allows the user to select one or more commodities. When the user selects purchase target commodities, a request message that includes model names and quantities of the kinds of selected commodities as parameters is transmitted from the user terminal 3 to the job processing server 12 and stored in an area (e.g.,., a shopping cart) for the user established in the memory 121. When the user performs an operation corresponding to an expression of the user's intention to decide purchase on a screen displayed on a display of the user terminal 3 according to the screen data transmitted from the job processing server 12, the process proceeds to step S002.

In step S002, the job processing server 12 executes purchaser information input processing. The job processing server 12 causes the user terminal 3, which is executing the WEB browser, to display an input screen having spaces, in which a name, an address, a telephone number, and an email address of the user should each be entered and a transmission button on the display of the user terminal 3. If the transmission button is operated, the job processing server 12 transmits screen data incorporating a setting for causing the character strings entered in the spaces to be sent back to the job processing server 12 as the name, the address, the telephone number, and the email address, respectively. When a message that includes purchaser information such as the name, the address, the telephone number, and the email address transmitted from the user terminal 3 in this way is received, the process advances to step S003.

In step S003, the job processing server 12 executes order decision processing. The job processing server 12 generates, on the basis of the models and the quantities of the kinds of commodities stored in the area of the shopping cart in step S001, prices (unit prices) stored in the commodity database 131 corresponding to each model name, a total amount calculated on the basis of the quantities and the prices of the kinds of commodities, and the purchaser information acquired at step S002, screen data that causes the user terminal 3 to display an order decision screen (see FIG. 11) in which the above information is written, and in which a correction button 31 and an order button 32 are included. A setting for transmitting a message indicating that button 31 or 32 has been operated to the job processing server 12 is incorporated in the screen data. When a message indicating that the correction button 31 has been operated is received from the user terminal 3 that is performing screen display based on the screen data according to a function of the WEB browser, the job processing server 12 executes the purchaser information input processing in step S002 again. On the other hand, when a message indicating that the order button 32 has been operated is received from the user terminal 3, the job processing server 12 generates a unique order number, and creates slip data from the order number and the information included in the order decision screen, and then the process advances to step S004.

In step S004, the job processing server 12 checks, on the basis of an application condition for each of the campaign kinds stored in the campaign database 134, whether or not the order content decided in step S003 includes a model name that is an application target of any one of the campaigns. As described above, when conditions other than the models of the commodities are set as application conditions for the campaigns, the job processing server 12 checks whether or not the order content decided by the user satisfies any one of the application conditions.

If the order content satisfies none of the application conditions (when the model included in the order content is not an application target of the campaign), the process advances directly to step S006. On the other hand, if the order content satisfies any one of the application conditions (when the model name included in the order content is an application target of the campaign), the process advances to step S005.

In step S005, the job processing server 12 reads out a campaign kind and the number of rights corresponding to the satisfied application conditions from the campaign database 134. The job processing server 12 generates a unique ID (the job processing server 12 at this time is equivalent to an identifier generator or identifier generating means). The job processing server 12 registers the ID, the number of rights, the campaign kind, and a date and time of use (NUL) in the campaign database 134 in association with one another (the job processing server 12 at this time is equivalent to a register or registering means, e.g., the number of rights is equivalent to information indicating the number of times a right may be exercised and, in particular, the number of rights equal to or larger than 1 is equivalent to information indicating that an authority is valid). At the same time, the job processing server 12 creates a one-time URL as a network address with the job processing server 12 itself set as a destination and with the ID (the job processing server 12 at this time is equivalent to a network-address generator or network-address generating means). Content of the one-time URL, as described in the example below, is content for requesting the shopping site 1 to apply a campaign:

https://www.shop-example.com/campaign?ID=xx&Sum=xx where, “Sum” is a security parameter such as a check sum. When step S005 is completed, the process advances to step S006.

In step S006, the job processing server 12 generates an order reception mail in which content of the slip data created in step S003 is described. If the one-time URL is created in step S005, the job processing server 12 additionally writes the one-time URL in the order reception mail. The job processing server 12 transmits the order reception mail created as described above to the email address included in the purchaser information acquired in step S002 (the job processing server 12 at this time is equivalent to a network-address notifier or network-address notifying means).

In the next step S007, the job processing server 12 registers the slip data created in step S003 in the order database 133. If customer information equivalent to the purchaser information acquired in step S002 is not registered in the customer information database 132 yet, the job processing server 12 registers the purchaser information in the customer information database 132. When step S007 is completed, the process is finished.

A user who receives the order reception mail transmitted in step S006 using any one of the user terminals 3 may use the one-time URL described in the order reception mail. The user may notify a third party of the one-time URL and allow the third party to use the one-time URL. In any case, a person who sets the one-time URL in a browser executed on any one of the user terminals 3 and causes the request message to reach the shopping site first is regarded as a person who has an access authority to the one-time URL.

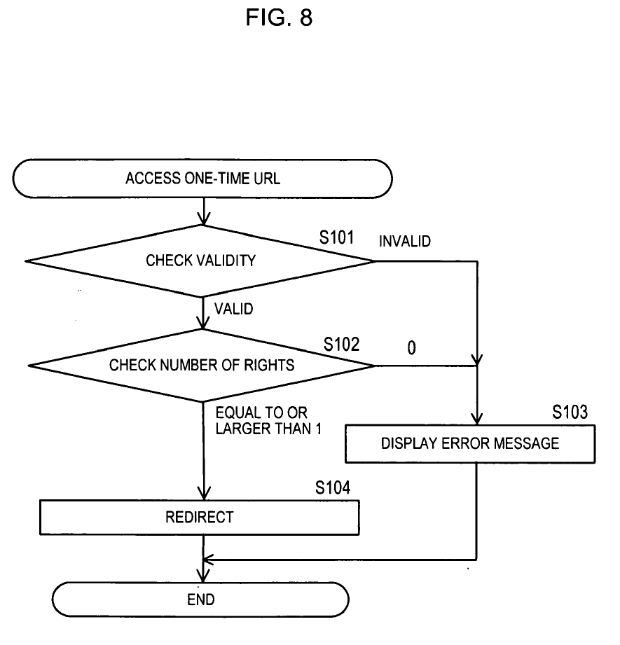

When the request message in which the one-time URL is designated reaches the shopping site 1 in this way, the job processing server 12 executes the process shown in FIG. 8. In first step S101 after the process shown in FIG. 8 is started, the job processing server 12 checks validity of the one-time URL using the security parameter such as check sum included in the one-time URL. If it is judged that the one-time URL is invalid, the job processing server 12 process advances to step S103. When it is judged that the one-time URL is valid, the process advances to step S102.

In step S102, the job processing server 12 reads out a remaining number of rights corresponding to the ID included in the one-time URL as a parameter from the campaign database 134 and checks whether or not the remaining number of rights is equal to or larger than 1. If the remaining number of rights is 0, the process advances to step S103. If the remaining number of rights is equal to or larger than 1, the process advances to step S104.

In step S103, the job processing server 12 transmits screen data for causing the user terminal 3 at the message transmission source to display an error message, which indicates that a URL is invalid or already applied, to the user terminal 3 at the message transmission source. Thereafter, the process is finished.

On the other hand, in step S102, the job processing server 12 generates a redirect parameter on the basis of the campaign kind (Kind), the remaining number of rights, and the URL of the campaign site 2 registered in the campaign database 134 in association with the ID. Content of the redirect parameter, as described in the example below, is content for redirecting a message to a given campaign site 2 and requesting application of a given campaign: https://www.campaign-example.com/redirect?ID=xx&Site=xxx&Kind=xxx&Num=xx&Sum=x x&Ret=xxx (where, “ID” is the ID included in the one-time URL, “Site” is an identifier for identifying the shopping site, “Kind” is a campaign kind, “Num” is the remaining number of rights, “Sum” is a security parameter such as check sum, and “Ret” is a parameter for designating a return destination [return URL] of the shopping site). The job processing server 12 redirects redirect information that includes the redirect parameter generated in this way to the user terminal 3 at the message transmission source (the job processing server 12 at this time is equivalent to a redirector or redirecting means).

In this way, a browser being operated on the user terminal 3 receives the redirected redirect information. The browser transmits a message (a message with the redirect parameter set as a URL) to the campaign site 2 as a redirect destination according to the redirect parameter in the redirect information.

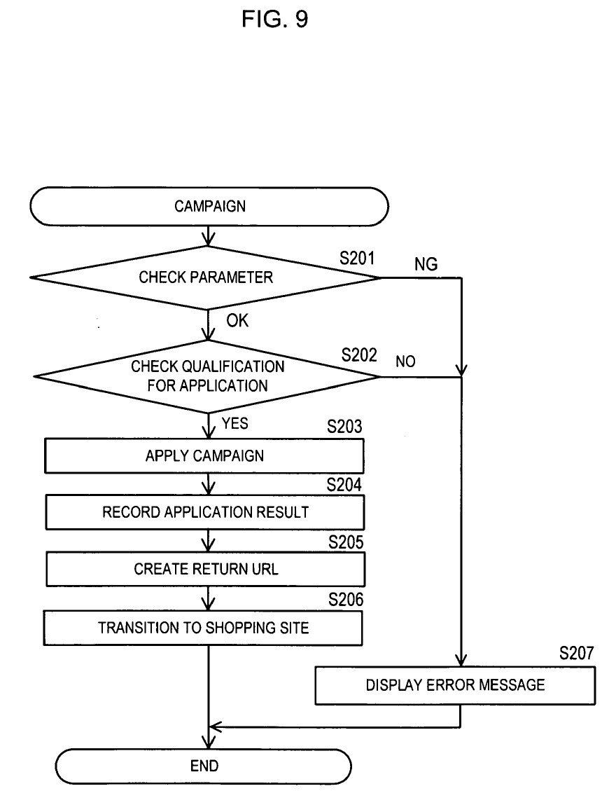

Then, in the campaign site 2 that receives this message, the job processing server 22 executes the process shown in FIG. 9. In the first step S201 after the process shown in FIG. 9 is started, the job processing server 12 checks validity of the redirect parameter (the URL) included in the message using a security parameter such as check sum included in the redirect parameter (the URL). If it is judged that the redirect parameter is invalid, the process advances to step S207. When it is judged that the redirect parameter is valid, the process advances to step S202.

In step S202, the job processing server 22 checks whether or not the redirect message has the qualification for application. If the ID included in the redirect parameter (the URL) of the redirect message is not registered in the campaign database 232 yet, the job processing server 22 judges that the redirect message has the qualification for application and the process advances to step S203. When the ID is already registered in the campaign database 232, the job processing server 22 reads out the remaining number of rights corresponding to the ID from the campaign database 232. If the remaining number of rights (Num) included in the redirect parameter is equal to or larger than the remaining number of rights read out from the campaign database 232, the job processing server 22 judges that the redirect message is an illegal access and does not have the qualification for application and the process advances to step S207. On the other hand, if the remaining number of rights (Num) included in the redirect parameter is smaller than the remaining number of rights read out from the campaign database 232, the job processing server 22 judges that the redirect message has the qualification for application and the process advances to step S203.

In step S203, the job processing server 22 reads out content of a privilege corresponding to the campaign kind (Kind) included in the redirect parameter (the URL) of the redirect message from the campaign database 231 and applies the campaign according to the content. For example, when the content of the privilege is delivery of download data, the job processing server 22 reads out the download data from a storage location defined in the campaign database 231 and transmits the download data to the user terminal 3 at the message transmission source. When the content of the privilege is a grant of a tangible object, the job processing server 22 exchanges a message with the user terminal 3 at the message transmission source to thereby acquire personal information (registrant information) of a person to whom the tangible object should be sent, creates a sending slip data, and notifies a delivery system, not shown, of the sending slip data. When the content of the privilege is an application for a prize, the job processing server 22 acquires personal information (registrant information) of an entrant from the user terminal 3 at the message transmission source, creates entry data, and notifies a prize-awarding system (not shown) of the entry data. FIG. 12 is a diagram of an example of a screen for acquiring such registrant information.

In the next step S204, the job processing server 22 records an application result of the campaign. If the ID included in the redirect parameter (the URL) of the redirect message is not registered in the application result database 232 yet, the job processing server 22 registers the ID in the application result database 232 in association with the remaining number of rights (Num) included in the redirect parameter (the URL). On the other hand, when the ID is already registered in the campaign database 232, the job processing server 22 overwrites the remaining number of rights registered in the campaign database 232 in association with the ID with the remaining number of rights (Num) included in the redirect parameter (the URL).

In the next step S205, the job processing server 22 adds the ID and the remaining number of rights (Num) to the parameter indicating the return destination (“Ret” e.g., a text of the return URL) of the shopping site included in the redirect parameter (the URL) of the redirect message to thereby create a return URL for returning to the shopping site. An example of the return URL is described below: https://www.shop-example.com/Ret?ID=xx&Num=xx&Sum=xx (where “ID” is the ID of the one-time URL included in the redirect parameter, “Num” is the remaining number of rights, and “Sum” is a security parameter such as check sum).

In the next step S206, the job processing server 22 responds to the user terminal 3 at an access source with the return URL and transitions the user terminal 3 to the original shopping site 1 (the job processing server 22 at this time is equivalent to a completion notifier or completion notifying means). When step S206 is completed, the process is finished.

On the other hand, in step S207, the job processing server 22 transmits screen data for causing the user terminal 3 at the message transmission source to display an error message, which indicates that the URL is invalid or already applied, to the user terminal 3 at the message transmission source. Thereafter, the job processing server 22 finishes this process.

The browser on the user terminal 3 receives the return URL. The browser transmits a message according to the return terminal to thereby transition an access destination to the original shopping site 1.

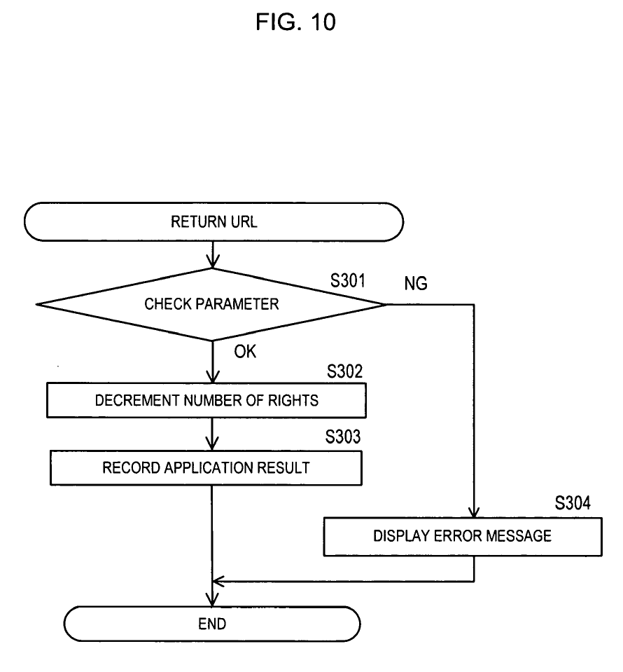

Then, in the shopping site 1 that receives this message, the job processing server 12 executes the process shown in FIG. 10. In first step S301 after the process of FIG. 10 is started, the job processing server 12 checks whether a parameter included in the message is described in a correct format. If it is judged that the parameter is not correctly described, in step S304 the job processing server 12 transmits screen data for causing the user terminal 3 at the message transmission source to display an error message indicating that the URL is invalid to the user terminal 3 at the message transmission source. Thereafter, the process is finished.

On the other hand, if it is judged that the parameter is correctly described, in step S303, the job processing server 12 registers the application result of the campaign in the campaign database 134. The job processing server 12 overwrites a present date and time as a date of use registered in the campaign database in association with the ID included in the return URL and decrements a value of the remaining number of rights by one (the job processing server 12 at this time is equivalent to an application recorder or application recording means). As a result of decrementing the value or the remaining number of rights in this way, the remaining number of rights corresponding to the ID is rewritten as zero. This is equivalent to updating the information indicating that an authority is valid to information indicating that the authority is invalid. Thereafter, even if an access is made to the shopping site by using the one-time URL that includes the ID, it is judged in step S102 of the process shown in FIG. 8 that the remaining number of rights is zero. Therefore, the redirect to the campaign site 2 (step S104) is not performed. In other words, the one-time URL is invalid after that. On the other hand, when the remaining number of rights is still equal to or larger than one even after the decrement, if an access is made to the shopping site by using an identical one-time URL including the ID, it is judged in step S102 of the process shown in FIG. 8 that the remaining number of rights is equal to or larger than one. Therefore, the redirect to the campaign site 2 (step S104) is performed. The user who transmits the message can receive granting of an incentive as a part of the campaign.

In this way, according to this embodiment, when an administrator of the shopping site 1 intends to conduct a campaign for granting a given incentive to a customer who satisfies a given application condition, such as a purchaser of a specific commodity, the administrator entrusts the consignee that manages the campaign site 2 with a job of granting an incentive as a part of the campaign. As a result, the granting of the incentive as a part of the campaign is performed in the campaign site 2 outside of the shopping site 1. Therefore, the administrator has to allow a person who desires application of the campaign to access the campaign site 2.

In this case, if the person can access the campaign site 2 only during the same session immediately after online shopping, the access cannot be resumed when the session is disconnected as described above. Therefore, in this embodiment, the URL (the one-time URL) indicating an access authority is notified to a commodity purchaser with an email to allow the commodity purchaser to request application of a campaign at any time later using the URL. As a result, the restriction that an access has to be made during the same session as the online shopping session, and the restriction that the identical user terminal 3 has to be used are made meaningless. Therefore, in this embodiment, a person who is notified of the URL can transfer the access authority to a third party by notifying the third party of the URL.

However, with these restrictions removed, when a URL of the campaign site 2 is directly notified to the person who desires the application of the campaign, an illegal access occurs as described above. Therefore, in this embodiment, rather than directly notifying a URL of the campaign site 2 to the commodity purchaser, the URL (the one-time URL) redirected to the campaign site 2 through the shopping site 1 is notified to the commodity purchaser. In other words, only an ID that contains abstract identification information is included in the URL (the one-time URL). Instead, in the shopping site 1, the URL of the campaign site 2 at a redirect destination is defined in the campaign database 134 according to the ID based on a campaign kind (Kind). When the shopping site 1 receives a message in which the URL (the one-time URL) is designated, the shopping site 1 reads out the URL of the campaign site 2 at the redirect destination from the campaign database 134 according to the campaign kind (Kind) corresponding to the ID in the URL, and redirects the URL to the campaign site 2. As a result, it is impossible to directly access the campaign site 2 from the user terminal 3. The ID is used for managing the number of times each URL (one-time URL) is used. In the shopping site 1, a remaining number of rights is recorded in the campaign database 134 for each individual ID. The remaining number of rights is decremented every time a campaign based on a URL (a one-time URL) including each of the IDs is applied (an incentive is granted). When the remaining number of rights is decremented to zero, application of a campaign based on a URL (a one-time URL) after that is rejected. As a result, it is possible to prevent a campaign from being endlessly applied on the basis of one URL (one-time URL).

With the disclosed campaign system, information indicating an access authority to a campaign site that grants a privilege as a part of a campaign given to a user whose situation of use in the service site on the first server satisfies a given requirement, e.g., the exercisable number of times of a network address, is limited to a given number of times. Therefore, it is possible to transfer the access authority to a third party by notifying the third party of the information. Moreover, while the access authority may be exercised at any time, it is possible to prevent an unauthorized access to a campaign dedicated page by a user or a third party.

What is claimed is:

1. A campaign system that, when a service provided by a service site on a first server through a network to a user who operates a user terminal satisfies a given condition, grants the user an authority for allowing the user to receive granting of a given privilege from a campaign site on a second server,
the first server comprising:
an identifier generator that generates a unique identifier when a service provided to a certain user satisfies the given condition;
a network-address generator that generates a network address with the first server set as a destination and with the identifier;
a register that registers, in a storage device, information indicating that the authority is valid in association with the identifier generated by the identifier generator;
a network-address notifier that notifies the user of the network address;
a redirector that responds to a terminal at a transmission source of the message with redirect information that includes the identifier, redirects the message to the campaign site, and causes the user to request granting of the privilege when a message with the network address set as a destination is received, if the information indicating that the authority is valid is registered in the storage device in association with the identifier included in the network address; and
an application recorder that, when completion notification including the identifier and indicating the completion of the granting of the privilege in the campaign site is received, updates the information registered in the storage device in association with the identifier to information indicating that the authority is invalid; and
the second server comprising:
a completion notifier that generates-notification of the completion including the identifier included in the redirect information and transmits the completion notification to the first server when, after the message redirected on the basis of the redirect information is received, processing for granting the privilege by the campaign site on the basis of the message is completed.

2. A campaign system that, when a service provided through a network to a user who operates a user terminal by a service site on a first server satisfies a given condition, grants the user an authority for allowing the user to receive granting of a given privilege from a campaign site on a second server,
the first server comprising:
identifier generating means for generating a unique identifier when a service provided to a certain user satisfies the given condition;
network-address generating means for generating a network address with the first server set as a destination and including the identifier;
registering means for registering, in a storage device, information indicating that the authority is valid in association with the identifier generated by the identifier generating means;
network-address notifying means for notifying the user of the network address;
redirecting means for responding to a terminal at a transmission source of the message with redirect information that includes the identifier, and that redirects the message to the campaign site and causes the user to request granting of the privilege when a message with the network address set as a destination is received, only if the information indicating that the authority is valid is registered in the storage device in association with the identifier included in the network address; and
application recording means for updating, when completion notification including the identifier and indicating the completion of the granting of the privilege in the campaign site is received, the information registered in the storage device in association with the identifier to information indicating that the authority is invalid, and
the second server includes completion notifying means for generating notification of the completion including the identifier included in the redirect information and transmits the completion notification to the first server when, after the message redirected on the basis of the redirect information is received, processing for granting the privilege by the campaign site on the basis of the message is completed.

3. A campaign system that, when a service provided through a network to a user who operates a user terminal by a service site on a first server satisfies a given condition, grants the user an authority for allowing the user to receive granting of a given privilege from a campaign site on a second server,
the first server comprising:
an identifier generator that generates a unique identifier when a service provided to a certain user satisfies the given condition;
a network-address generator that generates a network address with the first server set as a destination, and with the identifier;
a register that registers an initial value of an exercisable number of times of the authority in a storage device in association with the identifier generated by the identifier generator;
a network-address notifier that notifies the user of the network address;
a redirector that, when a message with the network address set as a destination is received and if the exercisable number of times registered in the storage device in association with the identifier included in the network address is equal to or larger than one, responds to a terminal at a transmission source of the message with redirect information including the identifier, and redirects the message to the campaign site to cause the user to request granting of the privilege; and
an application recorder that, when completion notification including the identifier and indicating that the granting of the privilege in the campaign site is completed is received, decrements the exercisable number of times registered in the storage device in association with the identifier, and
the second server comprising:
a completion notifier that, when, after the message redirected on the basis of the redirect information is received, processing for granting the privilege by the campaign site on the basis of the message is completed, generates notification of the completion including the identifier included in the redirect information, and transmits the completion notification to the first server.

4. A campaign system that grants the user an authority for allowing the user to receive granting of a given privilege from a campaign site on a second server when a service provided through a network to a user, who operates a user terminal, by a service site on a first server satisfies a given condition, wherein
the first server includes:
identifier generating means for generating a unique identifier when a service provided to a certain user satisfies the given condition;
network-address generating means for generating a network address with the first server set as a destination and including the identifier;
registering means for registering an initial value of a number of times that exercising of the authority is allowed in a storage device in association with the identifier generated by the identifier generating means;
network-address notifying means for notifying the user of the network address;
redirecting means for responding, when a message with the network address set as a destination is received, only if the number of times that exercising is allowed registered in the storage device in association with the identifier included in the network address is equal to or larger than one, to a terminal at a transmission source of the message with redirect information including the identifier and redirecting the message to the campaign site to cause the user to request granting of the privilege; and
application recording means for decrementing, when completion notification including the identifier and indicating that the granting of the privilege in the campaign site is completed is received, the number of times that exercising is allowed registered in the storage device in association with the identifier, and
the second server includes completion notifying means for generating notification of the completion including the identifier included in the redirect information when, after the message redirected on the basis of the redirect information is received, processing for granting the privilege by the campaign site on the basis of the message is completed, and transmits the completion notification to the first server.

5. A campaign method for executing a campaign for granting the user an authority for allowing the user to receive granting of a given privilege from a campaign site on a second server when a service provided through a network to a user, who operates a user terminal, by a service site on a first server satisfies a given condition, wherein
when a service provided to a certain user by the first server satisfies the given condition,
the first server generates a unique identifier, generates network address with the first server set as a destination and including the identifier, and registers information indicating that the authority is valid in a storage device in association with the identifier and notifies the user of the network address, and thereafter
when the first server receives a message with the network address set as a destination,
the first server responds to a terminal at a transmission source of the message with redirect information including the identifier and redirects the message to the campaign site and causes the user to request granting of the privilege only if the information indicating that the authority is valid is registered in the storage device in association with the identifier included in the network address, and thereafter
after the second server receives the message redirected on the basis of the redirect information,
the second server generates notification of the completion including the identifier included in the redirect information, and transmits the completion notification to the first server when processing for granting the privilege by the campaign site on the basis of the message is completed, and thereafter
when the first server receives the completion notification,
the first server updates the information registered in the storage device in association with the identifier included in the completion notification to information indicating that the authority is invalid.

6. A campaign method for executing a campaign for granting the user an authority for allowing the user to receive granting of a given privilege from a campaign site on a second server when a service provided through a network to a user, who operates a user terminal, by a service site on a first server satisfies a given condition, wherein
when a service provided to a certain user by the first server satisfies the given condition,
the first server generates a unique identifier, generates a network address with the first server set as a destination and that includes the identifier, registers an initial value of the number of times that exercising authority is allowed in a storage device in association with the identifier, and notifies the user of the network address, and thereafter
when the first server receives a message with the network address set as a destination,
the first server responds, only if the number of times that exercising is allowed registered in the storage device in association with the identifier included in the network address is equal to or larger than one, to a terminal at a transmission source of the message with redirect information including the identifier, and redirects the message to the campaign site and causes the user to request granting of the privilege, and thereafter
after the second server receives the message redirected on the basis of the redirect information,
the second server generates notification of the completion that includes the identifier included in the redirect information, and transmits the completion notification to the first server when processing for granting the privilege by the campaign site on the basis of the message is completed, and thereafter
when the first server receives the completion notification,
the first server decrements the number of times that exercising is allowed registered in the storage device in association with the identifier included in the completion notification.

7. A computer-readable recording medium having recorded therein a program for causing a server computer connected to a storage device to function, the server computer having a function of redirecting a message to a campaign site that executes processing for providing a user, who operates a user terminal, with a given service through a network and grants a given privilege to a sender of the message when a message to a given network address is received, the program comprising:
identifier generating means for generating a unique identifier when a service provided to a certain user satisfies a given condition;
network-address generating means for generating a network address with the server computer set as a destination and including the identifier;
registering means for registering information indicating that an authority is valid in the storage device in association with the identifier generated by the identifier generating means;
network-address notifying means for notifying the user of the network address;
redirecting means for responding to a terminal at a transmission source of the message with redirect information including the identifier and a parameter with the server computer set as a return destination and redirecting the message to the campaign site to cause the user to request granting of the privilege when a message with the network address set as a destination is received, only if the information indicating that the authority is valid is registered in the storage device in association with the identifier included in the network address; and
application recording means for updating the information registered in the storage device in association with the identifier to information indicating that the authority is invalid when a message including the identifier and transitioned from the campaign site is received.

8. A computer-readable recording medium having recorded therein a program for causing a server computer connected to a storage device to function, wherein the server computer has a function of redirecting a message to a campaign site that executes processing for providing a user, who operates a user terminal, with a given service through a network and grants a given privilege to a sender of the message when a message to a given network address is received, the program comprising:
identifier generating means for generating a unique identifier when a service provided to a certain user satisfies a given condition;
network-address generating means for generating a network address with the server computer set as a destination and including the identifier;
registering means for registering an initial value of a variable indicating a number of times in the storage device in association with the identifier generated by the identifier generating means;
network-address notifying means for notifying the user of the network address;
redirecting means for responding to a terminal at a transmission source of the message with redirect information including the identifier and a parameter with the server computer set as a return destination and redirecting the message to the campaign site to cause the user to request granting of the privilege when a message with the network address set as a destination is received, only if variable registered in the storage device in association with the identifier included in the network address is equal to or larger than one; and
application recording means for decrementing, when a message that includes the identifier and that is transitioned from the campaign site is received, the variable registered in the storage device in association with the identifier.
